(19) United States
(12) Patent Application Publication
(10) Pub. No.: US 2017/0218260 A1
(43) Pub. Date: Aug. 3, 2017

(54) DME Fracing

(71) Applicant: Neilin Chakrabarty, Calgary (CA)

(72) Inventor: Neilin Chakrabarty, Calgary (CA)

(21) Appl. No.: 15/008,801

(22) Filed: Jan. 28, 2016

(51) Int. Cl. C09K 8/68; E21B 43/267; E21B 43/26

(52) U.S. Cl. CPC C09K 8/68; E21B 43/26; E21B 43/267

(57) ABSTRACT

Herein is described a frac fluid comprising of di-methyl ether (DME) or a mixture of DME and propane to be used in hydraulic fracturing of underground formations.

### FIELD OF THE INVENTION

The invention relates to a composition of fracturing fluid used in hydraulic fracturing of underground formations. More specifically, it relates to using di-methyl ether (DME) or a mixture of propane and DME that will result in higher petroleum and natural gas production.

### BACKGROUND OF THE INVENTION

Hydraulic fracturing, or fracking, is a now common well stimulation technique used to extract natural gas and petroleum from shale rock layers or other unconventional formations that are not accessible by previous technology. Vertical or horizontal wells are drilled to inject hydraulically pressurized liquid (also known as frac fluid) into shale formations. The high pressure frac fluids cause the rock to fracture and create new channels to the wells for the natural gas and/or petroleum to be extracted. After the pressure is released and frac fluid is removed (flowback), these new channels are held open by fracturing proppants that are suspended in the fracking fluid. The wells then produces at higher rates and accesses more natural gas or petroleum reserves than what the rates would have been if no fracking was done.

The major components of frac fluids are primarily water or hydrocarbons and additives. The additives include proppants (particles that keep fractures open), acids, gelling agents (increases viscosity of the frac fluid), gel breakers (allows for frac fluid to flow easily back up the well), friction reducers, iron controls, scale inhibitors and surfactants.

Water based frac fluid is an environmental concern as the additives in it are toxic. After the fracking process has been completed, proper cleanup must occur and the recovered frac fluid must be stored in man-made tailing ponds or other onsite containers to prevent contamination of the ground and nearby potable water sources. Eventually the water must be treated to remove the chemicals.

The use of hydrocarbons such as low molecular weight alkanes have been proposed and used commercially. Liquefied C2-C6 hydrocarbon and carbon dioxide as a fracturing fluid is described in U.S. Pat. No. 3,368,627. Propane based frac fluid was used in the McCully tight gas field in New Brunswick, Canada, in 2009. Hydrocarbons are non-damaging to the formation and can vaporize as it mixes with reservoir gas and/or is soluble/miscible in the reservoir oil. By using a hydrocarbon based fracing fluid the flowback, cleanup and water handling processes are eliminated.

Di-methyl ether (DME) is a hydrocarbon that can be manufactured quite easily. Canadian patent no 2652930 describes a method of using DME in the recovery of heavy oil/bitumen as an improvement over using propane. The invention in this patent is an improvement over prior art in the field of hydraulic fracturing by using a frac fluid comprising of DME instead of other hydrocarbons currently used.

### SUMMARY OF THE INVENTION

Herein is described a frac fluid comprising of di-methyl ether (DME) or a mixture of DME and propane to be used in hydraulic fracturing of underground formations.

Compared to prior art, the use of DME in the frac fluid over other hydrocarbons such as alkanes provides the following advantages:

DME can be cheaper and more readily available than other hydrocarbons as it can be manufacture on-site using a small protion of the produced natural gas.

DME enhances the mobilization of oil and natural gas by dissolving water in the formation and dissolving polar and other components of the oil by being miscible gas, thereby increasing the gas and oil saturation which increase the oil and gas relative permeability. The higher relative permeabilities result in higher production rates.

DME or a DME and propane mixture also penetrates shale formations faster and deeper than alkanes alone.

### BRIEF DESCRIPTON OF THE DRAWINGS

FIG. 1 is a drawing of an example well to help illustrate the DME fracturing process.

FIG. 2 is a graph illustrating the improved rates and cumulative production in natural gas production by using a dimethyl ether-based fracing fluid over propane-based and water-based fracing fluid in a gas field.

FIG. 3 is a schematic process flow diagram of how produced natural gas from DME fracking can be used to manufacture more DME to be used in fracking and in diesel engines to power fracking operations.

### DETAILED DESCRIPTION OF THE PREFERRED EMBODIMENTS

Di-methy ether (DME) has a chemical formula CH₃OCH₃ and can be manufactured from a variety of sources, including natural gas, coal, waste from pulp and paper mills, forest products, agricultural by-products and municipal waste.

Unlike alkanes such as propane, DME when injected into a formation will increase oil and gas saturation. This will mobilize the oil and gas by reducing the relative permeability of water in the formation and increasing the relative permeability of the oil and gas. The oil in the formation will have its viscosity reduced as its components will be dissolved and diluted by DME. This will increase production rates.

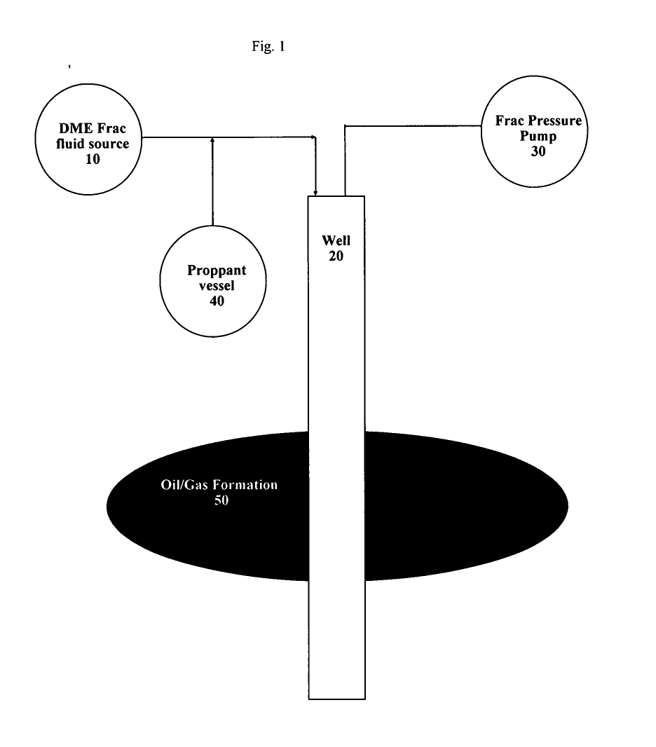

One embodiment of the invention is shown in FIG. 1. FIG. 1 shows a formation penetrated by a well. A pressurized frac fluid source 10 is used to supply a stream of frac fluid comprising DME into the well 20. A frac pressure pump 30 pressurizes the frac fluid in the well to create fractures in the formation. Proppant from pressure vessel 40 is then mixed into the stream of frac fluid and pumped into the well. The proppant's role is to keep the fractures open after the pressure is released. The pressure on the well is then released to allow the frac fluid to vaporize and return to the surface. Collection at the surface may be preformed to recover the DME to be used in future fracking operations.

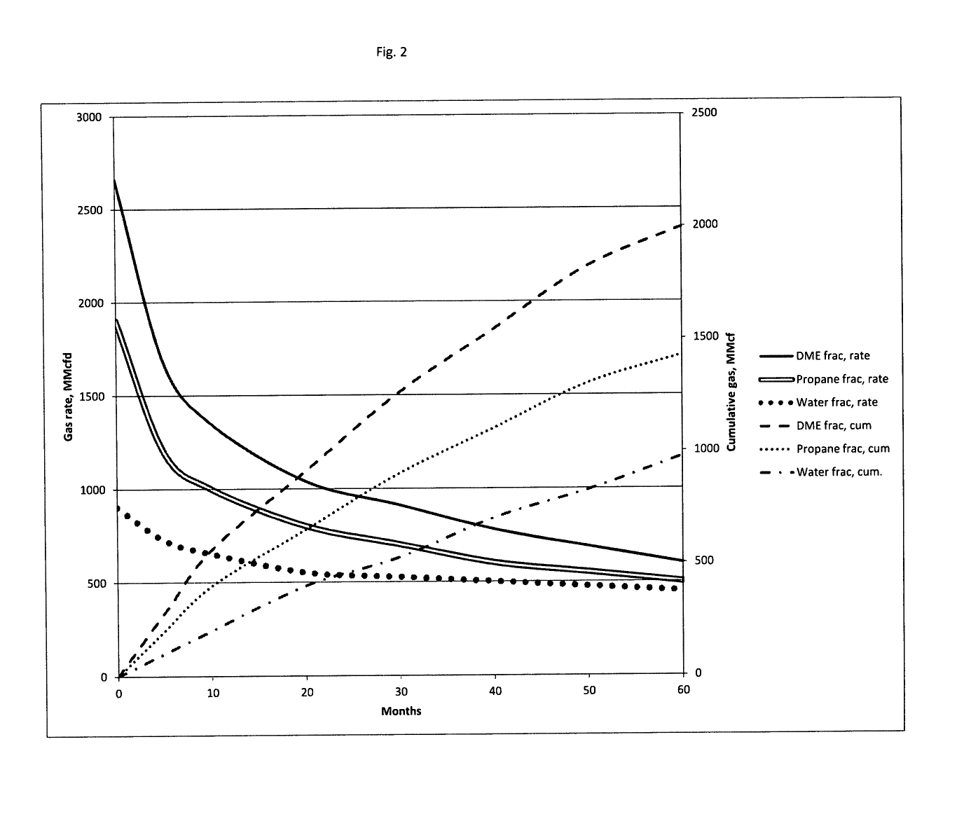

FIG. 2 shows the expected increase in production of a DME-based frac over that of propane-based frac, water-based frac and no frac.

Canadian Patent no 2718273 demonstrates that a mixture of DME and propane is more effective than propane in bitumen recovery. Therefore a mixture of DME and propane can be used instead.

To improve the performance of the fracture, additives are commonly added to frac fluid and may also be added to DME frac fluid. These can include, but are not limited, to gelling agents to increase viscosity, acids to further open fractures, gel breakers to decrease viscosity after fracturing is completed and aid in flowback, friction reducers, chemicals for iron controls, scale inhibitors, and/or surfactants.

Inert gases such as carbon dioxide and nitrogen and flue gases can be added to DME frac fluid. These gases will gasify into the formation and won't impede production. It also has the added benefit of reducing emissions into the air.

DME can also be produced directly from synthesis gas produced by the gasification of coal or biomass or through natural gas reforming. DME used in the frac fluid can be generated using these methods at a price competitive to that of liquefied petroleum gas (LPG) and condensate. Unlike other hydrocarbons, which may have to be pipelined/transported to the field, DME may be much more convenient and cheaper to use as it can be created on-site from various sources including produced natural gas.

As an integrated process, DME-based fracking can use the produced natural gas to manufacture more DME to be used in other fracking operations and/or to run diesel engines to provide power for fracking equipment. DME has a high cetane number and therefore works well in diesel engines.

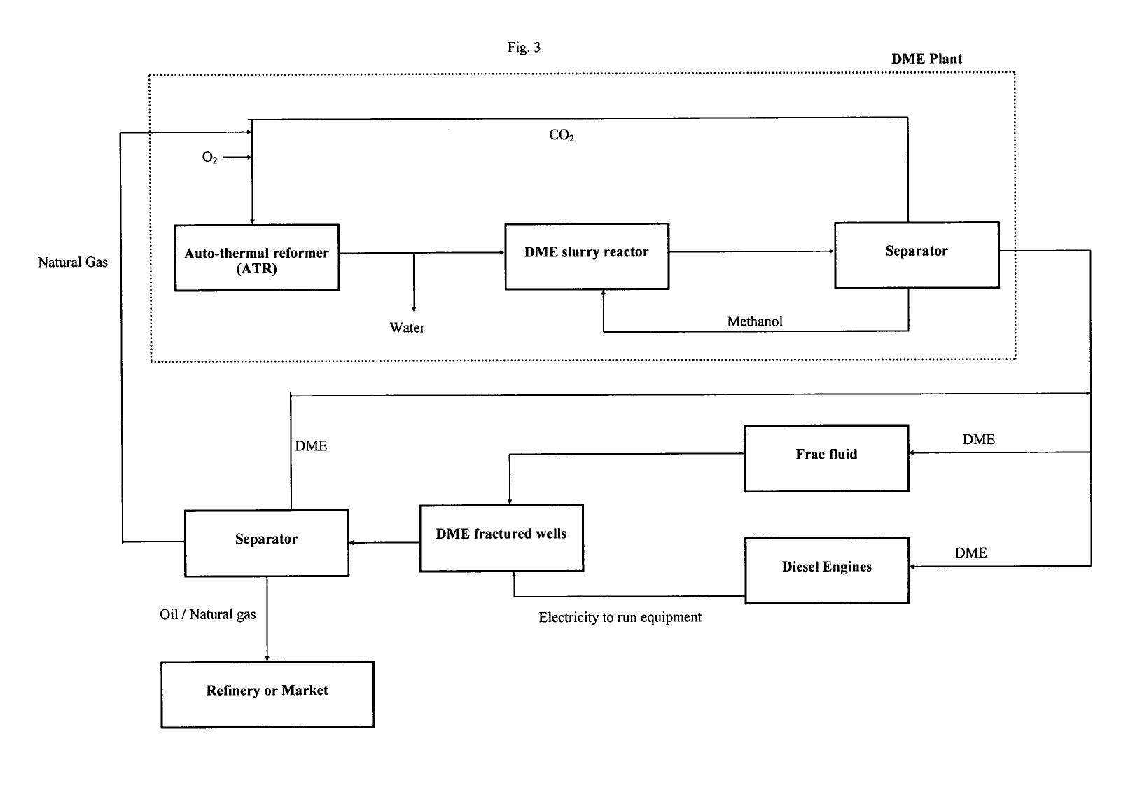

One embodiment of this integrated process is shown in FIG. 3. Produced natural gas is converted to synthesis gas with oxygen and by-product carbon dioxide in an auto-thermal reformer (ATR).

2CH₄+O₂+CO₂→3CO+3H₂+H₂O (ATR)

The synthesis gas is compressed and fed to a DME slurry reactor. The effluent from the reactor is DME, by-product carbon dioxide, small amounts of methanol and unreacted synthesis gas.

3CO+3H₂→CH₃OCH₃ (DME)+CO₂ (DME slurry reactor)

DME and other by-products are chilled and separated as liquid from the unreacted synthesis gas. The unreacted synthesis gas is recycled to the reactor. Carbon dioxide is recycled to the ATR and converted to the synthesis gas. Methanol is also recycled to the DME reactor to be converted to DME. The overall process of converting the natural gas to DME at a DME plant can be summed as:

2CH₄+O₂→CH₃OCH₃ (DME)+H₂O (DME plant)

DME plants can be small or large and still be economic.

1. A method for hydraulic fracturing as a well stimulation technique where a frac fluid comprising d-methyl ether (DME) is pumped into a well to create fractures in the formation. The method comprising the steps of:
a. Supplying a stream of frac fluid comprising of DME from a pressurized frac fluid source into a well
b. Pumping frac fluid in the well to create fractures in the formation
c. Supplying proppant into the stream of frac fluid from the frac fluid source
d. Pumping the proppant containing frac fluid stream into the well
e. Releasing pressure from the well to allow frac fluid to vaporize and return to surface
f. Collecting the frac fluid
g. Separating DME from the frac fluid to be recycled for step a

2. The method in claim 1, wherein the frac fluid comprises a mixture of DME and propane.

3. The method in claim 1 or 2, wherein additives such as gelling agents, acids, gel breakers, friction reducers, chemicals for iron controls, scale inhibitors, and/or surfactants are added to the frac fluid.

4. The method in 1, 2, or 3, wherein inert gas such as carbon dioxide, nitrogen and/or flue gases are added to the frac fluid.

5. The method in claim 2, 3, or 4, wherein the volume ratio of DME to propane is 10:90 to 90:10 measured at 22° C. and 1 MPa.

6. The method in claim 5, wherein the volume ratio of DME to propane is 20:80 to 70:30 measured at 22° C. and 1 MPa.

7. The method in claim 5, wherein the volume ratio of DME to propane is 22.5:77.5 to 50:50 measured at 22° C. and 1 MPa.

8. The method in any of the preceding claims, wherein DME is manufactured from the produced on-site natural gas.

9. The method in claim 8, wherein manufactured DME is used in diesel engines to power the equipment used in fracking or production.

10. (canceled)
